(19) United States
(12) Patent Application Publication
(10) Pub. No.: US 2008/0266037 A1
(43) Pub. Date: Oct. 30, 2008

(54) Magnetic Levitation Lithography Apparatus and Method

(76) Inventor: Mark Williams, Amherst, NH (US)

Correspondence Address: The Law Office of Steven G. Roeder, 5560 Chelsea Avenue, La Jolla, CA, 92037, US

(21) Appl. No.: 11/629,224

(22) PCT Filed: May 20, 2005
(86) PCT No.: PCT/US2005/017945

§ 371 Date: Dec. 11, 2006

Related U.S. Application Data
(60) Provisional application No. 60/580,468, filed on Jun. 17, 2004.

(51) Int. Cl. H01F 7/00

(52) U.S. Cl. 335/219

(57) ABSTRACT

A magnetic levitation lithography machine having a low spring stiffness to minimize disturbances of the first structure and which is capable of dynamically controlling the first structure in one or more degrees of freedom. The machine includes a radiation source, a patterning element configured to define a pattern, a projection element, the projection element configured to project the pattern onto a substrate when radiation from the radiation source is projected through the projection element; and a substrate take configured to support the substrate. The substrate take includes a second structure, a fine stage, and a magnetic support configured to support the fine stage adjacent the second structure. The magnetic support includes a first magnet element, coupled to the fine stage, having a first magnet polarization, a second magnet element, coupled to the course stage, having a second magnet polarization, the first magnet element being separated from the second magnet element by a gap, and an adjustment mechanism configured to adjust the magnetic force used to support the fine stage by varying the gap between the first magnet element and the second magnet element.

### RELATED APPLICATIONS

This application claims priority on Provisional Application Ser. No. 60/580,468 filed on Jun. 17, 2004 and entitled “Permanent Magnet Gravity Compensation Device”. The contents of Provisional Application Ser. No. 60/580,468 are incorporated herein by reference for all purposes.

### BACKGROUND

The present invention relates to lithography, and more particularly, to a magnetic levitation lithography apparatus and method that uses magnets to provide a static, gravity opposing force to support a fine stage over a coarse stage and to dynamically control the position of the fine stage in one or more degrees of freedom.

A typical lithography machine includes a radiation source, a patterning element, a projection system, and a wafer table to support a wafer. A radiation-sensitive material, such as resist, is coated onto the wafer surface prior to placement onto the wafer table. During operation, radiation energy from the radiation source is used to project the pattern defined by the patterning element through the projection system onto the wafer.

The projection area during an exposure is typically much smaller than the wafer. The wafer therefore has to be moved relative to the projection system to pattern the entire surface.

In the semiconductor industry, two types of lithography machines are commonly used. With so-called “step and repeat” machines, the entire pattern is projected at once in a single exposure onto a target area of the wafer. After the exposure, the wafer is moved or “stepped” in the x and/or y direction and a new target area is exposed. This step and repeat process is performed over and over until the entire wafer surface is exposed. With scanning type lithography machines, the target area is exposed in a continuous or “scanning” motion. The patterning element is moved in one direction while the wafer is moved in either the same or the opposite direction during exposure. The wafer is then moved in the x and y direction to the next scan target area. This process is repeated until all the desired areas on the wafer have been exposed.

With either type of machine, the wafer substrate table is used to move the wafer substrate. Wafer tables typically have two stages, a coarse stage and a fine stage. The coarse stage is used to move the wafer in the x and/or y directions from one target area to the next. The fine stage is used for minute adjustments and is capable of positioning the wafer in six degrees of freedom (x, y, z, ⊖n, ⊖y and ⊖z. Magnetic levitation is one known way to support the fine stage over the coarse stage. For more details on magnetic levitation, see U.S. Pat. Nos. 4,952,858, 5,157,296, 5,294,854, 3,935,486, 5,623,853, U.S. Patent Publications 2003/0173833A1, 2003/0052284 and British Patent Specification 1,424,413, each incorporated by reference herein for all purposes.

Ideally, a magnet levitation fine stage should have no vertical weight. In other words, the upward magnetic force completely offsets or compensates for the effects of gravity, resulting in a static vertical mass of zero for the fine stage. In the real world, a certain amount of stiffness will always be present between the fine and coarse stages. This stiffness, which is analogous to a spring, is problematic for several reasons. Any disturbances in the coarse stage are transmitted to the fine stage through the spring. The force of these disturbances can be modeled using equation [1] below.

[1] F=mg+kz, where
m=mass of the fine stage;
g=gravity;
k=the stiffness of the spring; and
z=the displacement of the fine stage in the vertical direction.
Based on equation [1], it is clear that the smaller the stiffness of the spring, the smaller the displacement force.

A magnetic levitation lithography machine having a low spring stiffness to minimize disturbances of the fine stage and which is capable of dynamically controlling the fine stage in one or more degrees of freedom is therefore needed.

### SUMMARY

A magnetic levitation lithography machine having a low spring stiffness to minimize disturbances of the fine stage and which is capable of dynamically controlling the fine stage in one or more degrees of freedom is disclosed. The machine includes a radiation source, a patterning element configured to define a pattern, a projection element, the projection element configured to project the pattern onto a substrate when radiation from the radiation source is projected through the projection element; and a substrate table configured to support the substrate. The substrate table includes a coarse stage, a fine stage, and a magnetic support configured to support the fine stage adjacent the coarse stage. The magnetic support includes a first magnet element, coupled to the fine stage, having a first magnet polarization, a second magnet element, coupled to the course stage, having a second magnet polarization, the first magnet element being separated from the second magnet element by a gap, and an adjustment mechanism configured to adjust the magnetic force used to support the fine stage by varying the gap between the first magnet element and the second magnet element.

### BRIEF DESCRIPTION OF THE DRAWINGS

FIG. 1 is a diagram of a lithography machine according to the present invention.

FIG. 2 is an enlarged view of the fine stage and coarse stage of the lithography machine of the present invention;

FIG. 3 is a model diagram of a magnet support used in the lithography machine of the present invention;

FIGS. 4A and 4B are a top-down views of a diagram of a magnet support according to a second embodiment of the present invention;

FIG. 5 is a cross sectional view of one embodiment of a first magnet assembly of the present invention.

FIG. 6A is a diagram of a second magnet assembly used in the magnet support of the Present invention;

FIG. 6B is a cross section diagram showing the magnet support for supporting a fine stage over a course stage according to the present invention.

FIGS. 7A-7C are various arrangements of the first and second magnets according to various embodiments of the invention.

FIGS. 8A and 8B are two more arrangements of magnet supports according to other embodiments of the invention.

FIG. 9 is a flow chart outlining a process for manufacturing a semiconductor device consistent with the principles of the present invention; and

FIG. 10 is a flow chart outlining the process of FIG. 9 in more detail.

### DESCRIPTION

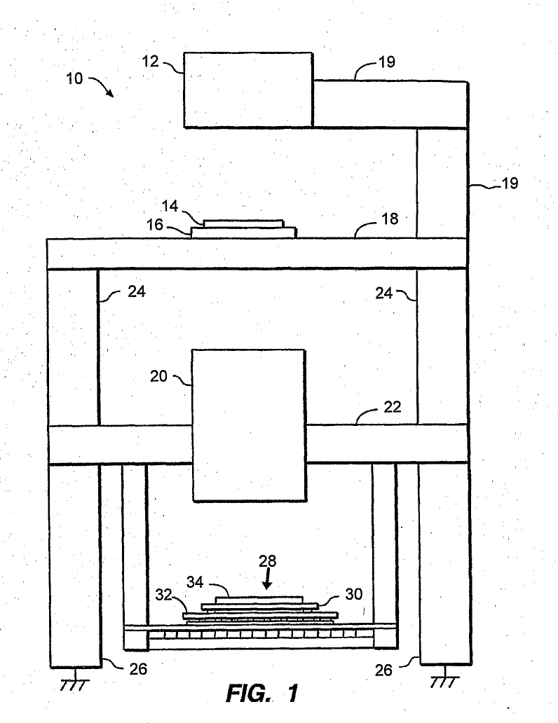

Referring to FIG. 1, a photolithography apparatus 10 according to the present invention is shown. The apparatus 10 includes an illumination system 12 that projects radiation energy through a patterning element 14 that is supported using a patterning stage 16. Patterning stage 16 is supported by frame 18. Frame members 19 are provided to support the illumination system 12 over the patterning element 14. The apparatus 10 also includes an optical projection system 20 that is supported by another frame 22. Frame members 24 support the projection system 20 below the patterning element 14. The frame 22 is anchored to ground through support members 26.

The apparatus 10 also includes a wafer table 28 that is suspended from frame 22 below the projection system 20. The wafer table 28 includes a fine stage 30 and a coarse stage 32. The fine stage 30 is used to support a wafer 34. The fine stage 30 is limited in travel to fine movements, for example 500 microns in total stroke, in one or more of the six degrees of freedom directions. The coarse stage 32 is used to support the fine stage 30 and is used for coarse positioning. For example, the coarse stage has a capability of traveling 300 mm in the X, and Y directions. The coarse stage may be moved by linear motors that include a fixed member (not shown) and a moving member 38 and positions the coarse stage in three degrees of freedom (in the X, Y directions and about the Z direction). The fine stage 30 may be moved by one or more actuators. The actuators may be, in different embodiments, linear motors, voice coil motors, or a combination thereof. Such actuator may include a fixed member (not shown) connected to the coarse stage 32 and a moving member connected to fine stage 30. The exposure area on the wafer 34 can therefore be precisely controlled by controlling the fine 30 and coarse 32 stages respectively.

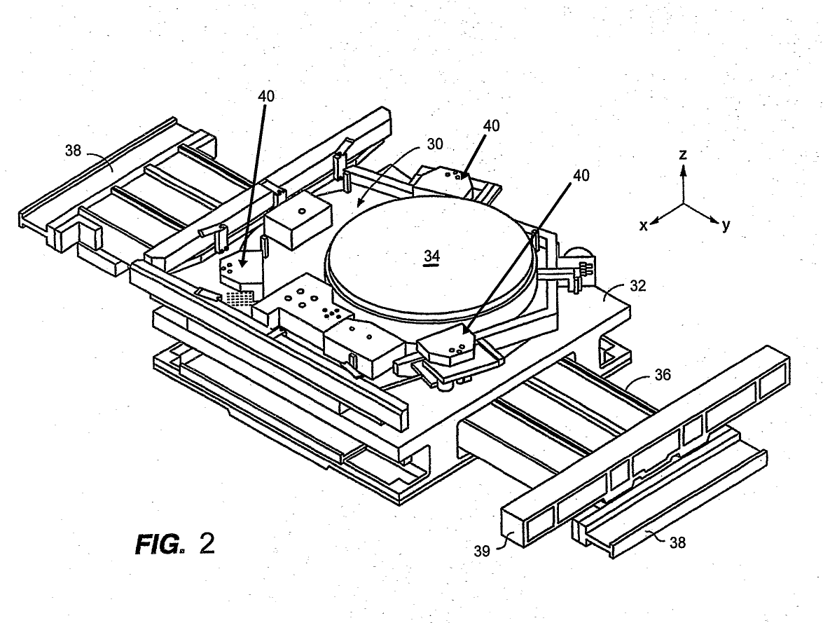

Referring to FIG. 2, an enlarged view of the fine stage 30 and coarse stage 32 is shown. The coarse stage is capable of moving in the Y direction along a guide beam 36 and the X direction with guide of the guide member 39. The coarse stage 32 is supported on a base (not shown) and is capable of moving in the Z direction using some type of moving device such as an actuator or bearing to support and move the coarse stage 32 in the Z direction. The fine stage 30 is mounted onto the coarse stage 32 and positioned by three sets of magnetic supports 40. The magnetic supports 40 are capable of controlling the position of the fine stage 30 in the X, Y and Theta Z (i.e., rotation in the X-Y plane).

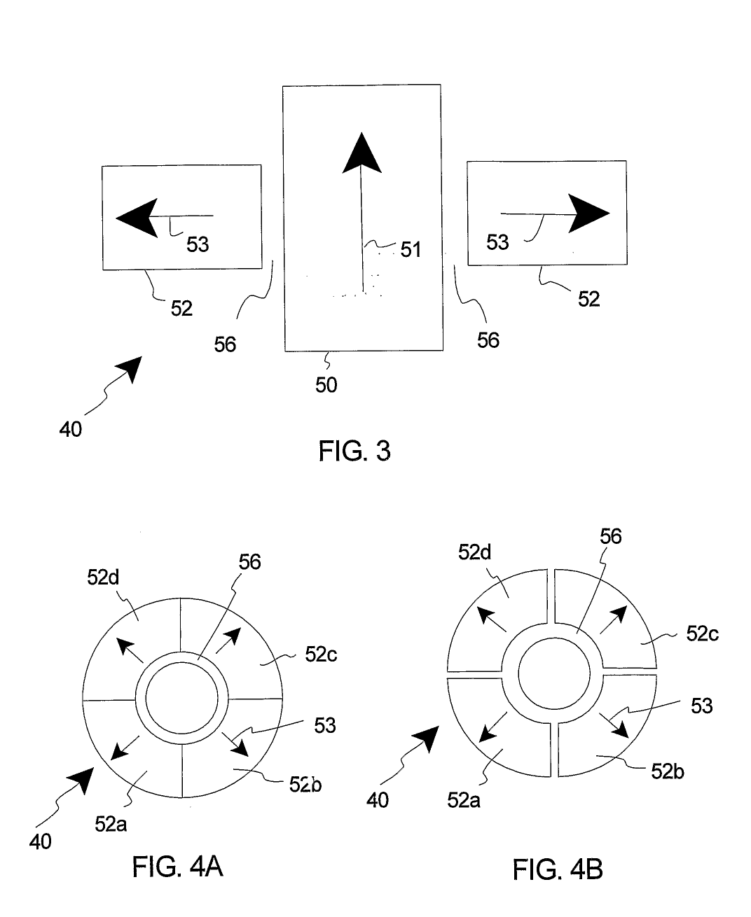

Referring to FIG. 3, a model diagram of a single magnetic support 40 is shown. The magnetic support 40 includes a first magnet 50 and a second magnet 52 that is annular in shape and surrounds the first magnet 50. The first magnet 50 generates a magnetic force designated by the arrow 51 in the general direction to support the fine stage 30 above or adjacent to the coarse stage 32. In other words, the first magnet 50 is configured to move in the vertical direction in this embodiment. The second magnet 52 has a magnetic polarization that is orthogonal to that of the first magnet 50, as designated by arrow 53. The magnetic force used to support the fine stage 30 is created by the magnetic interaction of the first magnet 50 and the second magnet 52. For example, the first magnet (magnetic member) 50 and the second magnet (magnetic member) 52 might be made of a rare earth magnet, such as NdFeb.

A gap 56 is provided between the first magnet 50 and the second magnet 52. By varying the gap 56, the magnetic force applied to the fine stage 30 is controlled. As the gap 56 decreases, the force increases, and vice-versa.

Referring to FIGS. 4A and 4B, a top-down view of a diagram of a magnetic support 40 is shown. In this view, the first magnet 50 is shown in the center of the annular shaped second magnet 52. The gap 56 separates the two magnets. In the embodiment shown, the second magnet 52 is made up of a plurality of magnetic segments 52a-52d that are symmetrically arranged around the first magnet 50. By radially moving or adjusting the magnet segments 52a-52d, the gap 56 can be varied. In FIG. 4A, the segments 52a-52d are radially adjusted inward. The gap 56 is therefore minimized. In FIG. 4B, the segments 52a-52d are radially adjusted outward, increasing the size of the gap 56.

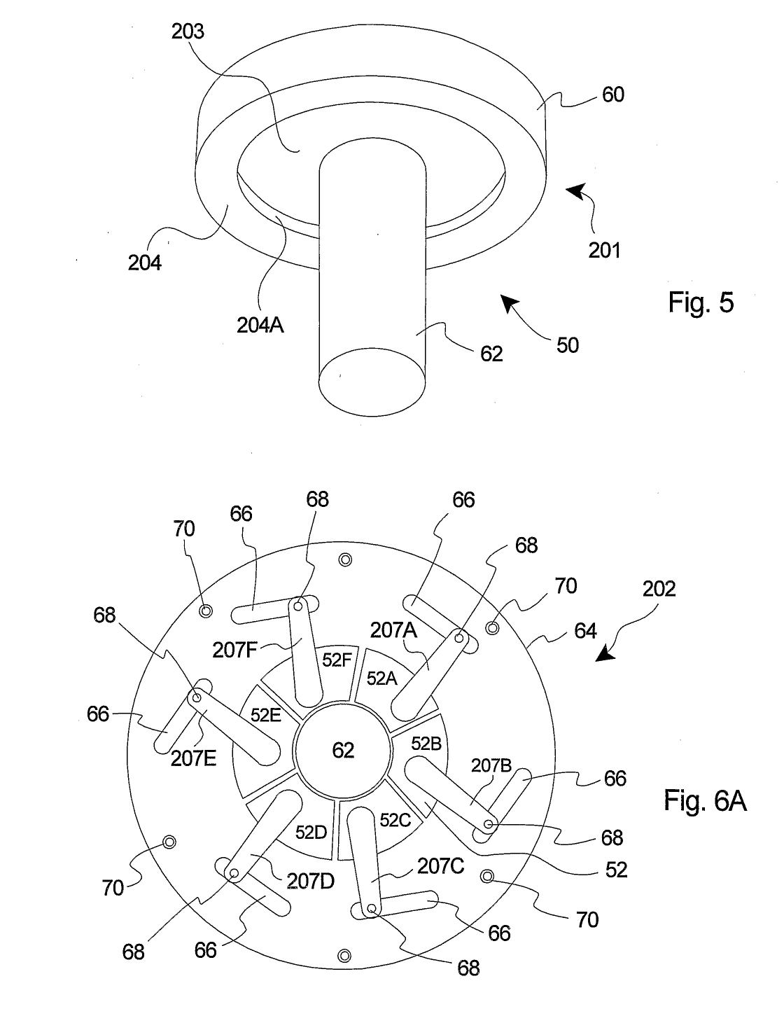

Referring to FIG. 5, a diagram of an assembly 201 including the first magnet 50 is shown according to one embodiment. The first magnet 50 includes a ring-shaped flat top surface 60, a bottom surface 203, a ring 204 arranged laterally around the bottom of the top surface 60, and a center plunger 62. The inner surface of the ring is defined by reference numeral 204a. The first magnet 50, as described below, forms a moving “plunger” designated by reference numeral 201, with respect to the second magnet 52.

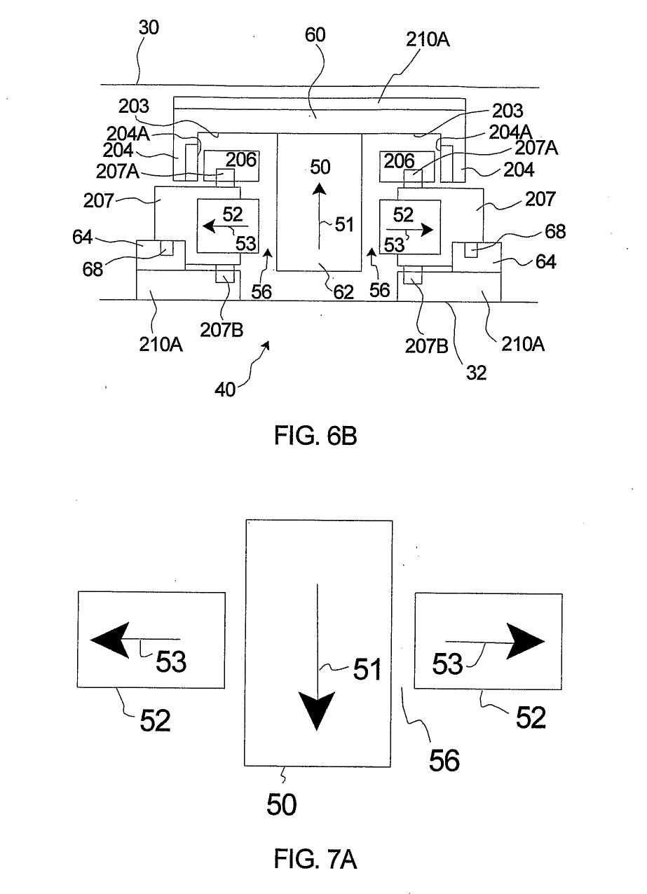

Referring to FIG. 6A, a diagram of an assembly 202 including the second magnet 52 is shown. The assembly 202 includes an annular ring 64 with a center opening to receive the center plunger 62 of the first magnet 50. In this view of the figure, only the plunger 62 of the first magnet 50 is illustrated. The ring shaped top surface 60 and the ring 204 are purposely not shown so that the features of the second magnet 52 can be illustrated. The annular ring 64 includes plurality of gap adjustment grooves 66. Each of the grooves 66 are designed to engage an adjustment pin 68 of a magnet segment 52a-52f of the second magnet 52. Each adjustment pin 68 is connected to a mount 207a-207f that is mounted to one of the magnet segments 52a-52f respectively. By rotating the annular ring 64, each of the adjustment pins 68 slides within the gap adjustment grooves 66. When the ring 64 is rotated clockwise, the pins are pulled inward within the grooves 66. As a result, the magnet segments 52a-52f are moved inward, decreasing the gap 56. Alternatively, the gap 56 is increased by rotating the ring 64 counter-clockwise, causing the pins 68 and magnet segments 52a-52f to be pulled outward. The magnet segments 52a-52f, ring 64, grooves 66, pins 68 and mounts 207a-207f thus provide an adjustment mechanism that can control the magnetic force used to support the fine stage 30 by varying the gap 56 between the first magnet 50 and the second magnet 52. A clamping mechanism, such as a clamp or screws, is used to clamp the ring 64 in place once the desired gap 56 is achieved.

Referring to FIG. 6B, a cross section diagram illustrating a magnet support 40 supporting a fine stage surface 30. The magnet support 40 includes the first magnet 50 and the second magnet 52. The first magnet 50 includes the ring shaped top surface 60, center plunger 62, bottom surface 203, and ring 204 with inner surface 204a. The arrow 51 designates the direction of the magnetic force of the first magnet 50. The second magnet 52 includes magnet segments (both designated by reference numeral 52), annular ring 64, grooves 66 (not visible), pins 68, and mounts 207. The arrows 53 designate the direction of the magnetic force of the magnet segments 52. Although not visible in the cross section of the figure, the assembly 202 may include a plurality of magnet segments 52, for example six, more than six, or less than six.

The annular ring 64 of the second assembly 202 is mounted onto an annular shaped fixed base 205 on the course stage 32. The course stage 32 also includes a second base 206, supported above the surface of the course stage 32, and configured to fit between the ring surface 204A and the plunger 62 and under the bottom surface 203 of the first magnet 50. The second base 206 is also annular shaped and is configured to allow the plunger 62 of the first magnet 50 to move up and down with respect to the course stage 32. The mounts 207 each have an upper pin 207A configured to engage the second base 206 and a lower pin 207b configured to engage the fixed base 205. Together, the pins 207A and 207B allow the mounts 207 to be rotated so that when the annular ring 64 is rotated, the pin 68 can be positioned within the grooves 66 (not illustrated) so that the magnets 52 can be radially moved in and out to vary the size of the gap 56.

In an alternative embodiment, the fine stage 30 can be supported by both the magnet structure 40 and an air bearing. With this embodiment, as illustrated in FIG. 6B, an air bearing surface 210A is provided on the top surface 60 of the first magnet 50. The air bearing 210A is positioned under the surface of the fine stage 30 without contacting the fine stage surface 30. The air bearing surface 210A creates sufficient pressure, along with the magnetic force, to support the fine stage 30. The fine stage can thus be easily moved in the horizontal direction. In addition, air bearing surfaces may be provided along the surface 204A of magnet 50 and the opposing surface of second base 206. A journal bearing is thus created between the two opposing air bearing surfaces, for movement of the first magnet 50 along and about the Z axis with respect to the second assembly 202.

In yet another embodiment, the second assembly 202 might be coupled to the fine stage 30 instead of the coarse stage 32. In this case, the flat top surface 60 of the first assembly 201 faces to the coarse stage 32 and an air bearing is formed between the flat top surface 60 and a partial surface of an upper part of the course stage 32 for the horizontal degree of freedom (along the X and Y axes and about the Z axis) of the fine stage 30 relative to the coarse stage 32.

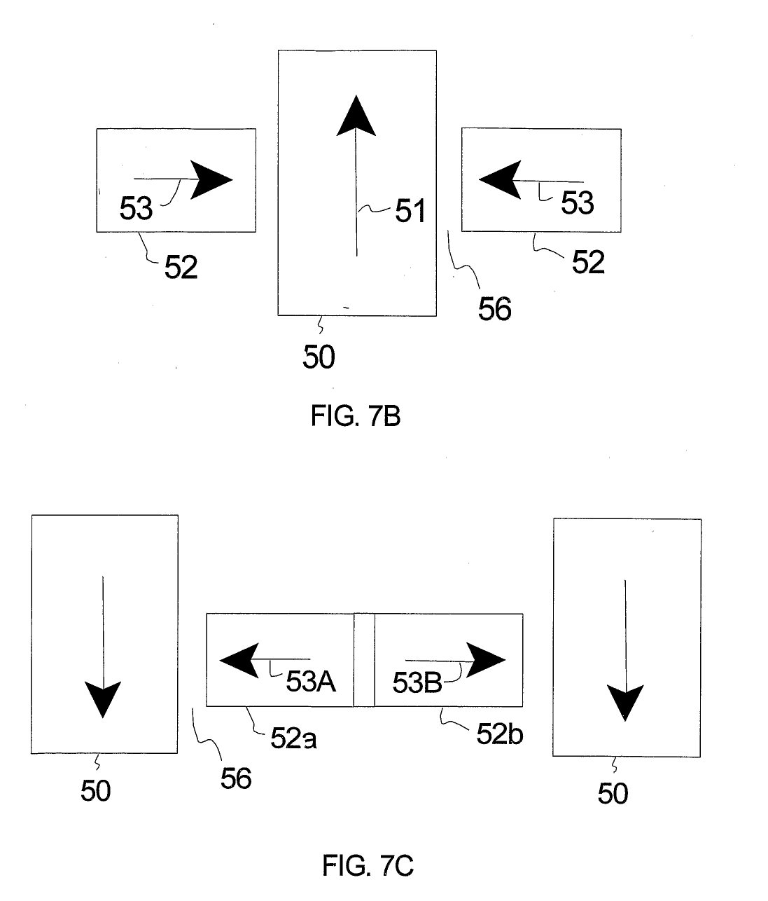

Referring to FIGS. 7A-7C, several different magnet arrangements are illustrated according to various other embodiments of the invention. Each of these embodiments are characterized in having (i) a first magnet element having a first magnet polarity; (ii) a second magnet having a second magnet polarity, perpendicular to the first magnet; and (iii) an adjustment mechanism to adjust the gap between the two magnets to adjust the magnetic force. In FIG. 7A for example, a first magnet 50 has a magnetic polarization 51 pointing downward and a second magnet 52 with an orthogonal polarization directed outward. In FIG. 7B, the first magnet 50 having a polarization 51 directed upward and a second magnet 52 having an orthogonal polarization 53 directed inward. In FIG. 7B, the first magnet 50 surrounds the second magnet made up of two segments 52a and 52b. The magnet 50 has a polarization that is directed downward. The second magnet 52 has a two segments 52a and 52b with orthogonal polarizations 53a and 53b directed in opposite directions. In each embodiment 7A-7C, a gap 56 separates the two magnets. The gap adjustment mechanism illustrated and described above with regard to FIGS. 5, 6A and 6B can be used to adjust the gap 56 in each of these embodiments.

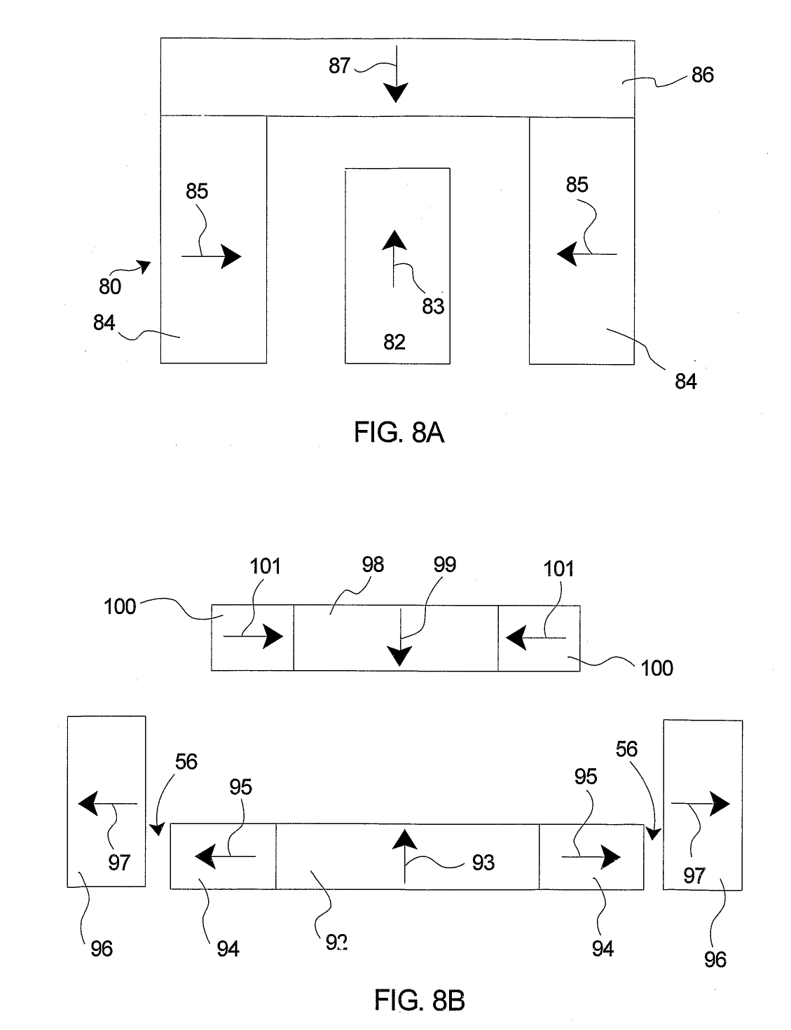

Referring to FIG. 8A, another magnetic support arrangement according to the present invention is shown. The magnetic support 80 includes a first magnet 82 and a second magnet 84 that is annular and surrounds the first magnet 82. The first magnet 82 generates an upward force, as designated by arrow 83. The second magnet 84 has a magnetic polarization that is orthogonal to the first magnet 82 polarization, as designated by arrow 85. A third magnet 86, with a downward polarization as indicated by arrow 87, is arranged above magnets 82 and 84. The third magnet 86 generates an additional force for the same size magnet support. The third magnet 86, however, generates a greater stiffness. The first magnet 82 is movable in the Z direction relative to the second and the third magnets 84 and 86 as a moving plunger.

Referring to FIG. 8B, another magnetic support arrangement is shown. The magnetic support 90 includes a first magnet 92, which has a polarization directed upward as designated by arrow 93 and a second annular magnet 94 that surrounds the first magnet 92. The second magnet has a polarization that is orthogonal to the first, as designated by arrow 95. The magnetic support 90 also has a third annular magnet 96 that surrounds the second magnet 94 with a polarization opposite the second magnet 94, as designated by arrow 97. A fourth magnet 98, provided above the first and second magnets, has a polarization directed down, as designated by arrow 99. A fifth angular magnet 100 surrounds the fourth magnet 98 and has a polarization orthogonal to the fourth magnet, as designated by the arrow 101. The first and second magnets 92 and 94 are cylinder and annular shaped and are forced together. The fourth and fifth magnets have the same arrangement. The annular third magnet 96 surrounding the other magnets reduces stiffness within a predetermined operating range.

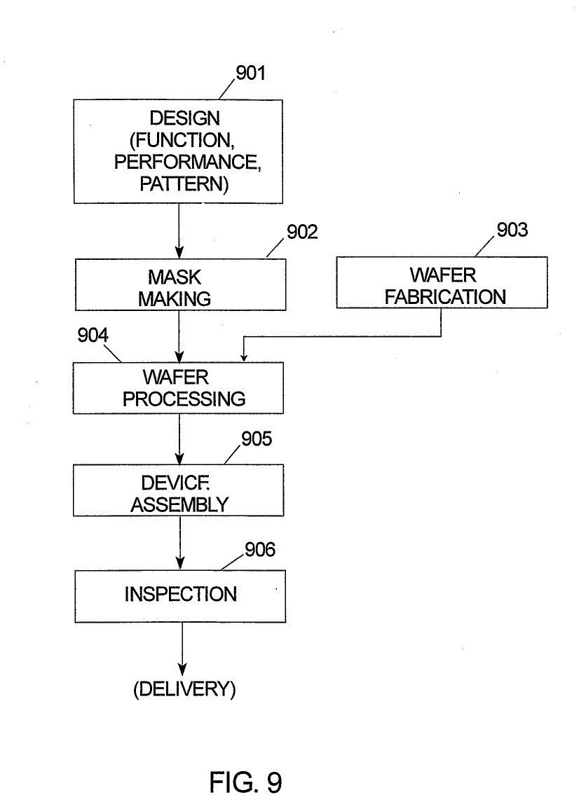

As described above, a photolithography system according to the above described embodiments can be built by assembling various subsystems, including each element listed in the appended claims, in such a manner that prescribed mechanical accuracy, electrical accuracy and optical accuracy are maintained. In order to maintain the various accuracies, prior to and following assembly, every optical system is adjusted to achieve its optical accuracy. Similarly, every mechanical system and every electrical system are adjusted to achieve their respective mechanical and electrical accuracies. The process of assembling each subsystem into a photolithography system includes mechanical interfaces, electrical circuit wiring connections and air pressure plumbing connections between each subsystem. Needless to say, there is also a process where each subsystem is assembled prior to assembling a photolithography system from the various subsystems. Once a photolithography system is assembled using the various subsystems, total adjustment is performed to make sure that accuracy is maintained in the complete photolithography system. Additionally, it is desirable to manufacture an exposure system in a clean room where the temperature and humidity are controlled. Further, semiconductor devices can be fabricated using the above described systems, by the process shown generally in FIG. 9. In step 301 the device's function and performance characteristics are designed. Next, in step 302, a mask (reticle) having a pattern is designed according to the previous designing step, and in a parallel step 303, a wafer is made from a silicon material. The mask pattern designed in step 302 is exposed onto the wafer from step 303 in step 304 by a photolithography system described hereinabove consistent with the principles of the present invention. In step 305 the semiconductor device is assembled (including the dicing process, bonding process and packaging process), then finally the device is inspected in step 306.

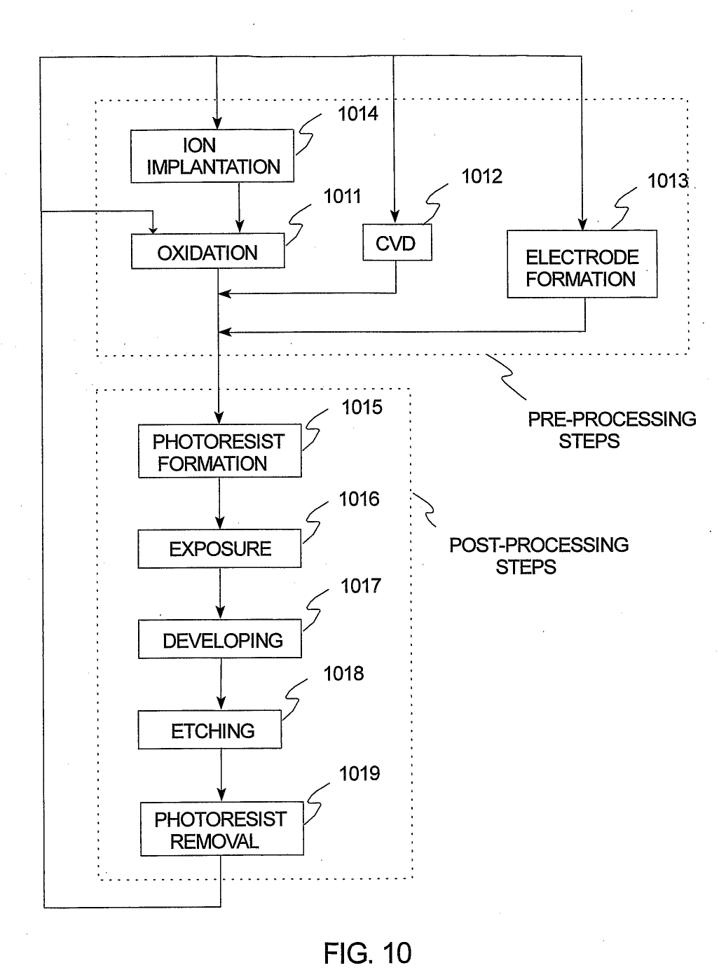

FIG. 10 illustrates a detailed flowchart example of the above-mentioned step 304 in the case of fabricating semiconductor devices. In step 311 (oxidation step), the wafer surface is oxidized. In step 312 (CVD step), an insulation film is formed on the wafer surface. In step 313 (electrode formation step), electrodes are formed on the wafer by vapor deposition. In step 314 (ion implantation step), ions are implanted in the wafer. The above mentioned steps 311-314 form the preprocessing steps for wafers during wafer processing, and selection is made at each step according to processing requirements.

At each stage of wafer processing, when the above-mentioned preprocessing steps have been completed, the following post-processing steps are implemented. During post-processing, initially, in step 315 (photoresist formation step), photoresist is applied to a wafer. Next, in step 316, (exposure step), the above-mentioned exposure device is used to transfer the circuit pattern of a mask (reticle) to a wafer. Then, in step 317 (developing step), the exposed wafer is developed, and in step 318 (etching step), parts other than residual photoresist (exposed material surface) are removed by etching. In step 319 (photoresist removal step), unnecessary photoresist remaining after etching is removed.

Multiple circuit patterns are formed by repetition of these preprocessing and post-processing steps.

This invention can be utilized in an immersion type exposure apparatus with taking suitable measures for a liquid. For example, PCT patent application WO 99/49504 discloses an exposure apparatus in which a liquid is supplied to the space between a substrate (wafer) and a projection lens system in exposure process. As far as is permitted, the disclosures in WO 99/49504 is incorporated herein by reference.

In various embodiments of the invention, the magnets 50 and 52 may be either permanent and/or electromagnetic. The present invention may also be used with an illumination system that projects radiation energy in one of but not limited to the following wavelengths 365, 248, 193, 157, 126 nms or EUV in the 5-20 nm range. Also the patterning element 14 may be either a mask or reticle or a programmable LCD array such as described in U.S. Pat. Nos. 5,296,891, 5,523,193 and PCT applications WO 98/38597 and 98/33096, each incorporated by reference herein.

Further, this invention can be utilized in an exposure apparatus that comprises two or more substrate and/or reticle stages. In such apparatus, the additional stage may be used in parallel or preparatory steps while other stage is being used for exposing. Such a multiple stage exposure apparatus are described, for example, in Japan patent Application Disclosure No. 10-163099 as well as Japan patent Application Disclosure No. 10-214783 and its counterparts U.S. Pat. No. 6,341,007, No. 6,400,441, No. 6,549,269 and No. 6,590,634. Also it is described in Japan patent Application Disclosure No. 2000-505958 and its counterparts U.S. Pat. No. 5,969,441 as well as U.S. Pat. No. 6,208,407. As far as is permitted, the disclosures in the above-mentioned U.S. patents, as well as the Japan patent applications are incorporated herein by reference.

This invention can be utilized in an exposure apparatus that has a movable stage retaining a substrate (wafer) for exposing it, and a stage having various sensors or measurement tools for measuring, as described in Japan Patent Application Disclosure No. 11-135400. As far as is permitted, the disclosures in the above-mentioned Japan patent application is incorporated herein by reference.

It should be noted that the particular embodiments described herein are merely illustrative and should not be construed as limiting. Rather, the true scope of the invention is intended to be determined by the accompanying claims.

What is claimed is:

1. An apparatus, comprising:
a second structure;
a first structure; and
a magnetic support configured to support the first structure adjacent the second structure, the magnetic support including:
a first magnet element, coupled to the first structure, having a first magnet polarization;
a second magnet element, coupled to the second structure, having a second magnet polarization perpendicular to the first magnet polarization, the first magnet element being separated from the second magnet element by a gap; and
an adjustment mechanism being configured to adjust the magnetic force used to support the first structure by varying the gap between the first magnet element and the second magnet element.

2. The apparatus of claim 1, wherein the first magnet element generates the magnetic force in the direction to support the first structure adjacent the second structure.

3. The apparatus of claim 1 wherein the first magnet element is configured to move in a vertical direction to support the first structure adjacent the second structure.

4. The apparatus of claim 1, wherein the second magnet element is stationary and the first magnet element is shaped as a plunger and is configured to move relative to the stationary second magnet.

5. The apparatus of claim 1, wherein the magnetic force is created by the magnetic interaction of the first magnet and the second magnet.

6. The apparatus of claim 1, wherein the first magnet element is configured to have a magnetic polarization that is oriented to be substantially in parallel with the magnetic force applied to the first structure.

7. The apparatus of claim 1, wherein the first magnet element is configured to have a magnetic polarization that is oriented to be substantially in anti-parallel with the magnetic force applied to the first structure.

8. The apparatus of claim 1, wherein the first magnet element is configured to have a magnet polarization that is oriented to be substantially orthogonal with the magnetic force applied to the first structure.

9. The apparatus of claim 1, wherein the second magnet element is annular in shape and substantially surrounds the first magnet element.

10. The apparatus of claim 1, wherein the second magnet element comprises a plurality of magnet segments, the magnet segments being symmetrically arranged around the first magnet element.

11. The apparatus of claim 10, wherein the adjustment mechanism is configured to radially adjust the magnet segments to vary the gap between the first magnet element and the magnet segments of the second magnet element.

12. The apparatus of claim 10, wherein each magnet segment includes an adjusting pin, a magnet, and a mount configured to hold the magnet and adjusting pin together.

13. The apparatus of claim 12, wherein the second magnet element further comprises an annular ring configured to substantially surround the first magnet element, the annular ring including gap adjustment grooves configured to engage the adjusting pins of the magnet segments respectively.

14. The apparatus of claim 13, wherein the second magnet element further comprises a clamping element configured to clamp the magnet segments in the gap adjustment grooves after the gap is adjusted.

15. The apparatus of claim 1, wherein the magnetic force applied to the first structure increases as the gap decreases and vice-versa.

16. The apparatus of claim 1, wherein the second magnet element is configured to have a magnet polarization that is oriented to be substantially orthogonal with the magnetic force applied to the first structure.

17. The apparatus of claim 1, wherein the second magnet element is configured to have a magnet polarization that is orientated to be substantially parallel with the magnetic force applied to the first structure.

18. The apparatus of claim 1, further comprising a third magnet, located adjacent the first magnet arid the second magnet, the third magnet positioned to increase the magnetic force generated by the first magnet and the second magnet.

19. The apparatus of claim 18, further comprising an annular magnet substantially surrounding the first, second and third magnets, the annular magnet configured to reduce the stiffness created by the first, second and third magnets.

20. An exposure apparatus that forms an image onto the substrate, comprising:
a substrate table that retains the substrate and includes a coarse stage and a fine stage; and
the apparatus according to claim 1; wherein
the first structure of the apparatus includes the fine stage and the second structure of the apparatus includes the coarse stage; and
the magnet support of the apparatus supports the fine stage adjacent the coarse stage.

21. An apparatus that supports a first structure relative to a second structure, comprising:
a first assembly that includes a first magnetic member having a first magnetic polarization; and
a second assembly that includes a second magnetic member having a second magnetic polarization; wherein
the direction of the first magnetic polarization of the first magnetic member is substantially parallel to a support direction of the first assembly;
a cross section of the first magnetic member cut by a plane perpendicular to the support direction has a circular outer periphery;
the second magnetic member surrounds at least an outer surface of a part of the first magnetic member with a gap;
the direction of the second magnetic polarization is different from the direction of the first magnetic polarization;
the first magnetic member and the second magnetic member present magnetic force therebetween; and
one of the first assembly and the second assembly is connected to the first structure and the other of the first assembly and the second assembly is connected to the second structure.

22. The apparatus of claim 21, wherein at least one of the first assembly and the second assembly includes an adjuster that varies the gap between the first magnetic member and the second magnetic member in the plane that is substantially parallel to the direction of the second magnetic polarization.

23. The apparatus of claim 21, wherein the second assembly includes an adjuster that changes position of the second magnetic member relative to the first magnetic member in the plane that is substantially parallel to the direction of the second magnetic polarization.

24. The apparatus of claim 21, wherein the second magnetic member includes a plurality of magnet segments, at least one of the magnet segments is movable relative to the other magnet segment.

25. The apparatus of claim 21, further comprising a bearing device disposed between the first assembly and the second assembly, the bearing device allowing relative motion between the first and second assemblies.

26. An exposure apparatus including the apparatus of claim 21.

27. A device manufactured with the exposure apparatus of claim 26.

28. A wafer on which an image has been formed by the exposure apparatus of claim 26.

29. The apparatus of claim 1, wherein the adjustment mechanism is coupled to the first structure.

30. The apparatus of claim 1, wherein the adjustment mechanism is coupled to the second structure.

31. The apparatus of claim 1, wherein the adjustment mechanism is coupled to the first and second structures.
